(19) United States
(12) Patent Application Publication
(10) Pub. No.: US 2024/0400014 A1
(43) Pub. Date: Dec. 5, 2024

(54) CONTROL DEVICE FOR MOTORCYCLE

(71) Applicant: HONDA MOTOR CO., LTD., Tokyo (JP)

(72) Inventors: Yotaro ABE, Tokyo (JP); Shogo KANAUMI, Tokyo (JP); Shunichi MIYAGISHI, Tokyo (JP); Toshio ISHIKURA, Tokyo (JP)

(21) Appl. No.: 18/698,015

(22) PCT Filed: Oct. 19, 2021
(86) PCT No.: PCT/JP2021/038646

§ 371 Date: Apr. 2, 2024

(51) Int. Cl. B60T 8/24; B60T 8/26; B60W 10/184

(52) U.S. Cl. CPC B60T 8/24; B60T 8/26; B60W 10/184

(57) ABSTRACT

Provided is a control device for motorcycle capable of carrying out assist control appropriate for a motorcycle during a turn travel. This control device for motor cycle comprises: a lean angle detection unit which detects the lean angle of a motorcycle; a throttle grip opening degree detection unit; a throttle valve control unit which controls a throttle valve; a brake control unit which controls a font wheel brake and a rear wheel brake; and a control unit which controls the throttle valve control unit and the brake control unit, wherein the control unit controls the throttle valve, the front wheel brake, and the rear wheel brake during a turn travel of the motorcycle. The control unit applies the rear wheel brake harder than the front wheel brake during the turn travel of the motorcycle.

### TECHNICAL FIELD

The present invention relates to a control device for a motorcycle, and particularly relates to a control device for a motorcycle, which assists driver's operation so that the motorcycle can properly pass a corner of a road.

### BACKGROUND ART

Conventionally, a control device for a vehicle has been known, which assists driver's operation so that the vehicle can properly pass a corner of a road.

Patent Document 1 discloses a control device for a four-wheeled vehicle, which properly performs assist control of engine output and brake pressure during turning so that the four-wheeled vehicle can pass a corner of a road with a desired turning radius.

### CITATION LIST

### Patent Document

Patent Document 1: Japanese Patent No. 4052963

### DISCLOSURE OF THE INVENTION

### Problems to be Solved by the Invention

However, the control device of Patent Document 1 is applied to the four-wheeled vehicle, and particularly for a motorcycle in which front and rear brakes are independently operated and a vehicle body posture is easily changed along with a change in engine output, unique assist control needs to be performed.

An object of the present invention is to solve the above-described problem of the related art and provide a control device for a motorcycle, which can execute assist control suitable for the motorcycle during turning.

### Means for Solving the Problems

In order to accomplish the above-described object, a control device for a motorcycle (1) according to the present invention includes an inclination angle detector (13) that detects the inclination angle of the motorcycle (1), a throttle grip opening detector (23), a throttle valve controller (11) that controls a throttle valve (21), a brake controller (12) that controls a front wheel brake (22) and a rear wheel brake (17), and a controller (10) that controls the throttle valve controller (11) and the brake controller (12), and has such a first feature that the controller (10) controls at least the throttle valve (21), the front wheel brake (22), and the rear wheel brake (17) during turning of the motorcycle (1).

Moreover, the control device has such a second feature that the controller (10) operates the rear wheel brake (17) with greater force than that for the front wheel brake (22) during the turning of the motorcycle (1).

### Effects of the Invention

According to the first feature, in the control device for the motorcycle (1), which includes the inclination angle detector (13) that detects the inclination angle of the motorcycle (1), the throttle grip opening detector (23), the throttle valve controller (11) that controls the throttle valve (21), the brake controller (12) that controls the front wheel brake (22) and the rear wheel brake (17), and the controller (10) that controls the throttle valve controller (11) and the brake controller (12), the controller (10) controls at least the throttle valve (21), the front wheel brake (22), and the rear wheel brake (17) during turning of the motorcycle (1). Thus, during turning of the motorcycle, for example, the brakes are operated along with closing of a throttle grip by a driver so that the driver can be assisted to easily drive the motorcycle.

The control unit operates the front wheel brake and the rear wheel brake with favorable balance during turning of the motorcycle, and deceleration by the brakes is cancelled by an operation of opening the throttle valve. Thus, a vehicle body behavior can be stabilized without changing vehicle body deceleration characteristics and turning can be facilitated. The amounts of operation of the front wheel brake, the rear wheel brake, and the throttle valve are changed according to the inclination angle of a vehicle body as if an experienced driver operates these parts, so that the motorcycle can smoothly turn. Drive parts (gears and drive chains) can contact an acceleration gear surface even during deceleration, and therefore, there is also an effect of suppressing a behavior change due to backlash in a drive system and stably accelerating the vehicle.

According to the second feature, the controller (10) operates the rear wheel brake (17) with the greater force than that for the front wheel brake (22) during the turning of the motorcycle (1). Thus, the vehicle body behavior can be stabilized by the control being performed such that the rear wheel brake is dragged during turning of the motorcycle, and turning can be facilitated.

### BRIEF DESCRIPTION OF THE DRAWINGS

FIG. 1 is a right side view of a motorcycle according to one embodiment of the present invention;

FIG. 2 is a schematic diagram of a test course; and

FIG. 3 is a graph showing transition of a vehicle speed, a throttle grip opening, a roll angle, a front wheel brake fluid pressure, a rear wheel brake fluid pressure, a throttle butterfly opening, a vertical load on a front wheel tire, and a vertical load on a rear wheel tire during turning.

### PREFERRED MODE FOR CARRYING OUT THE INVENTION

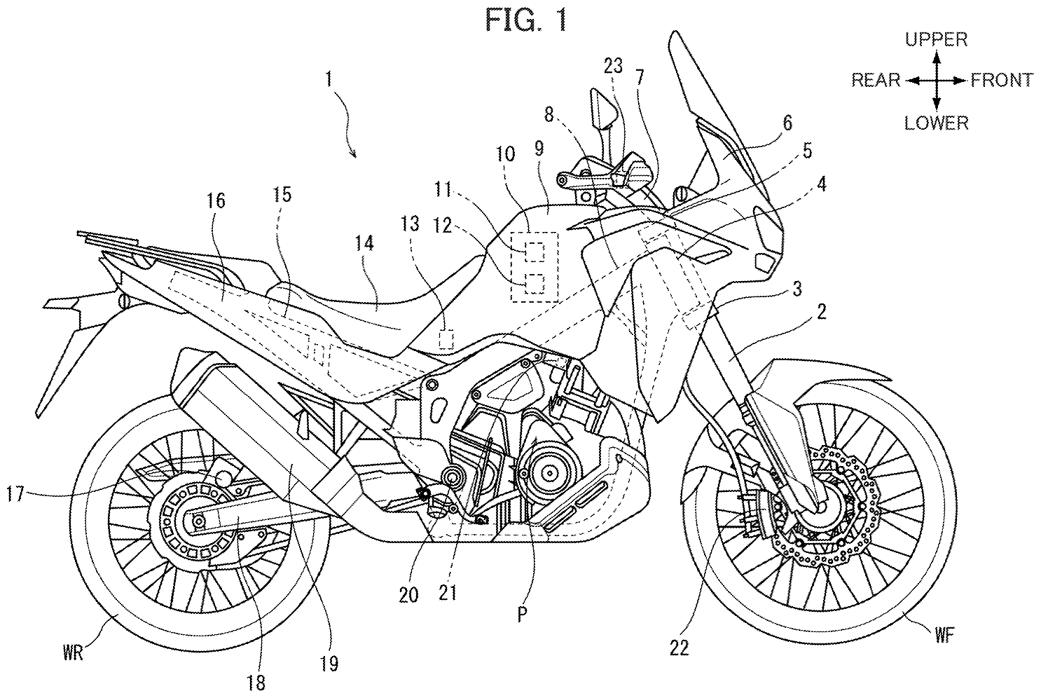

Hereinafter, a preferred embodiment of the present invention will be described in detail with reference to the drawings. FIG. 1 is a right side view of a motorcycle 1 according to one embodiment of the present invention. The motorcycle 1 is a saddled vehicle that travels by transmitting the drive force of a power unit P to a rear wheel WR. A head pipe 4 swingably pivotally supporting a not-shown steering stem is provided at a front end portion of a vehicle body frame 8.

A top bridge 5 and a bottom bridge 3 supporting a pair of right and left front forks 2 are fixed to the upper and lower sides of the steering stem. A front wheel WF is rotatably pivotally supported at a lower end portion of the front fork 2. A front wheel brake 22 that applies braking force to the front wheel WF is attached to the front fork 2. Steering handlebars 7 are fixed to an upper portion of the top bridge 5, and a front cowl 6 is arranged in front of the steering handlebars 7.

A fuel tank 9 is arranged at an upper portion of the vehicle body frame 8, and the power unit P is hung from a lower portion of the vehicle body frame 8. The power unit P includes a throttle valve 21 that adjusts the output of an internal-combustion engine. Combustion gas in the power unit P is discharged rearward from a muffler 19. A rear frame 15 coupled to a rear portion of the vehicle body frame 8 supports a seat 14 and a rear cowl 16.

A pivot 20 provided at a lower portion of the rear end of the vehicle body frame 8 swingably pivotally supports a swing arm 18 extending rearward. A rear end portion of the swing arm 18 rotatably pivotally supports the rear wheel WR. A rear wheel brake 17 that applies braking force to the rear wheel WR is attached to the swing arm 18.

The motorcycle 1 according to the present embodiment is characterized in that the throttle valve 21, the front wheel brake 22, and the rear wheel brake 17 are automatically operated to assist driver's operation so that the motorcycle 1 can properly pass a corner of a road. Not only the throttle valve 21, the front wheel brake 22, and the rear wheel brake 17 can be operated by a driver, but also intervention control by an actuator can be performed.

A controller 10 of the motorcycle 1 includes a throttle valve controller 11 that controls the throttle valve 21 and a brake controller 12 that controls the front wheel brake 22 and the rear wheel brake 17. An inclination angle sensor 13 which is an inclination angle detector that detects the inclination angle (roll angle) of a vehicle body of the motorcycle 1 is arranged at the center of the vehicle body. A throttle opening sensor 23 which is a throttle grip opening detector is arranged in the steering handlebars 7. When it is determined based on a throttle grip opening output signal that the motorcycle 1 is traveling while decelerating, the controller 10 drives the throttle valve 21, the front wheel brake 22, and the rear wheel brake 17 in a predetermined mode.

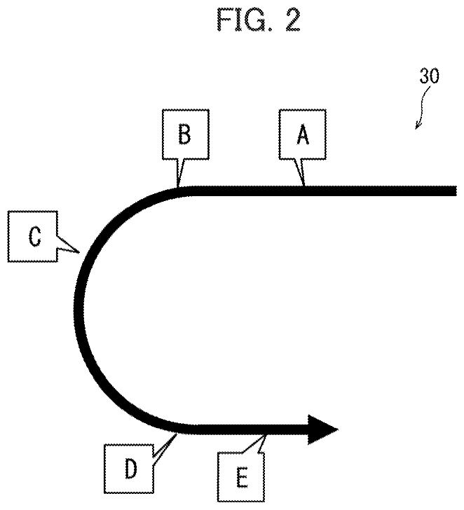

FIG. 2 is a schematic diagram of a test course 30. The test course 30 is a counterclockwise course including a combination of two straight lines and one semicircle, and a section from an A-point at which the driver starts deceleration to a D-point through a B-point and a C-point is a turning section. A course from the D-point to an E-point draws a straight line again. The controller 10 of the motorcycle 1 drives the throttle valve 21, the front wheel brake 22, and the rear wheel brake 17 to assist the driver's operation in the turning section from the A-point to the D-point. A control device for the motorcycle according to the present embodiment can execute control similar to control executed on the test course 30 at right and left corners of a normal load.

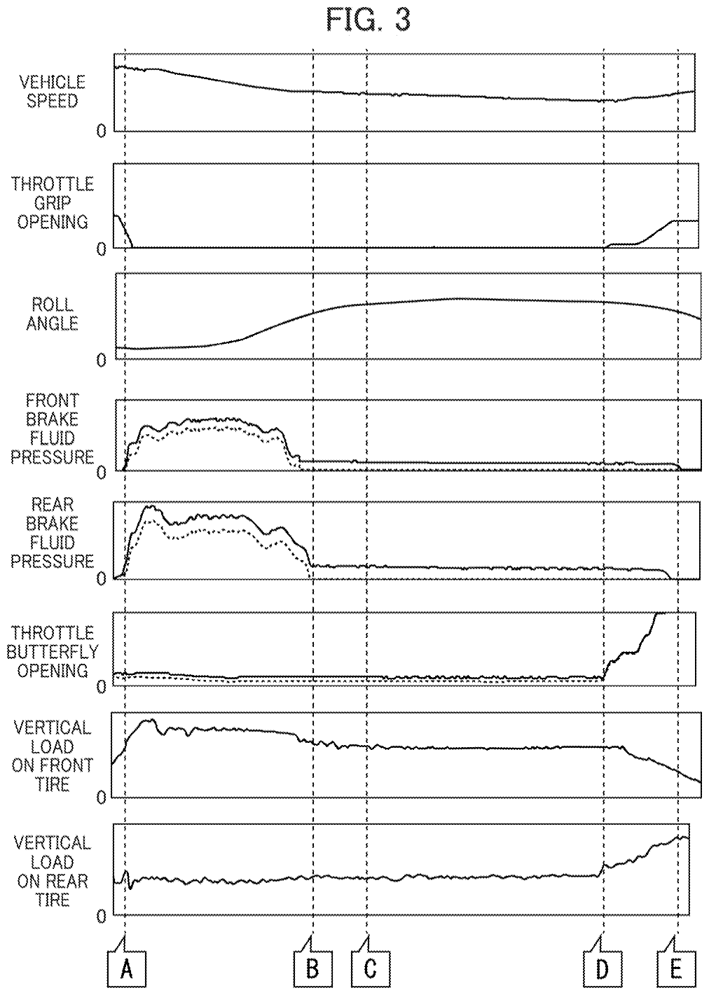

FIG. 3 is a graph showing transition of a vehicle speed, a throttle grip opening, a roll angle, a front wheel brake fluid pressure, a rear wheel brake fluid pressure, a throttle butterfly opening, a vertical load on a front wheel tire, and a vertical load on a rear wheel tire during turning. This graph shows a control mode in a section from before the A-point at which the driver starts deceleration to after the E-point at which turning ends on the test course 30 shown in FIG. 2. Moreover, this graph shows a result obtained by a combination of throttle operation by the driver and throttle control by the controller and a combination of brake operation by the driver and brake control by the controller. The result obtained by the driver's operation is indicated by a dashed line, and the result to which a control amount is added is indicated by a solid line.

At the A-point which is the start point of deceleration, the front wheel brake 22 and the rear wheel brake 17 are operated by the driver's operation, and the throttle grip opening decreases to zero. Accordingly, the vehicle speed starts decreasing, and the motorcycle 1 easily transitions to turning. The roll angle gently increases from the A-point which is the point of transition to turning, and is maintained at a certain angle after the B-point and the C-point. From the D-point, the vehicle starts accelerating by the rider opening a throttle grip, and the vehicle speed increases. As the vehicle accelerates, the roll angle decreases.

By the driver's operation, the fluid pressures of the front wheel brake 22 and the rear wheel brake 17 rapidly increase from the A-point at which the driver starts deceleration. When the throttle grip opening reaches a certain value or less, the intervention control by the brake controller 12 starts, and the fluid pressures of the front wheel brake and the rear wheel brake 17 are maintained at higher pressures than the fluid pressures in the rider's operation. Even when the driver ends the operation of the front wheel brake 22 and the rear wheel brake 17 at the B-point, the intervention control by the brake controller is continued. Accordingly, the behavior of the vehicle body can be stabilized by the control being performed such that the front wheel brake 22 and the rear wheel brake 17 are dragged, and turning can be facilitated. The fluid pressures of the front wheel brake 22 and the rear wheel brake 17 start decreasing from the C-point at which the roll angle reaches a certain value or more, and through the D-point at which the driver opens the throttle grip, return to zero at the E-point at which the vehicle fully transitions to an acceleration state. Accordingly, the vehicle body behavior in the second half of turning can be stabilized, and acceleration can be smoothly started.

Along with the operation of the front wheel brake 22, the load on the front wheel tire rapidly increases after the A-point, and gently decreases from the D-point at which the driver opens the throttle grip. Meanwhile, the load on the rear wheel tire temporarily greatly decreases after the A-point as the output of the power unit P decreases and the vehicle body tilts forward by braking, and thereafter, gently increases from the D-point at which acceleration is started. The vehicle behavior can be stabilized by the automatic control of the throttle valve 21, the front wheel brake 22, and the rear wheel brake 17, and therefore, the load on the front wheel tire and the load on the rear wheel tire can entirely gently transition and tire grip during turning can be stabilized.

As described above, according to the control device for the motorcycle according to the present invention, the controller 10 controls the throttle valve 21, the front wheel brake 22, and the rear wheel brake 17 during turning of the motorcycle 1. Thus, during turning of the motorcycle 1, for example, the front wheel brake 22 and the rear wheel brake 17 are operated along with closing of the throttle grip by the driver so that the driver can be assisted to easily drive the motorcycle 1. Note that the front wheel brake 22 and the rear wheel brake 17 can be continuously operated during turning. Thus, the brakes are constantly dragged during turning so that the behavior of the vehicle body can be stabilized and turning can be facilitated. Moreover, deceleration by the brakes is cancelled by an operation of opening the throttle valve controller 11 so that the vehicle body behavior can be stabilized without changing vehicle body deceleration characteristics and turning can be facilitated.

Note that the form of the motorcycle, the structures of the throttle valve and the front and rear brakes, etc. are not limited to those of the above-described embodiment and various changes can be made thereto. For example, the controller can detect, based on information from a camera or a radar that detects a road condition in front thereof, that the motorcycle approaches a corner, and can start driving the front and rear brakes and the throttle valve. The control device according to the present invention is not limited to the motorcycle, and can be applied to, e.g., a straddled tricycle configured such that front and rear brakes are independently controlled. Moreover, the control device can be applied not only to the power unit of the internal-combustion engine, but also to an electric vehicle.

### EXPLANATION OF REFERENCE NUMERALS

1: Motorcycle, 10: Controller, 11: Throttle valve controller, 12: Brake controller, 13: Inclination angle detector, 17: Rear wheel brake, 21: Throttle valve, 22: Front wheel brake, 23: Throttle grip opening detector

1. A control device for a motorcycle, comprising:
an inclination angle detector that detects an inclination angle of the motorcycle;
a throttle grip opening detector;
a throttle valve controller that controls a throttle valve;
a brake controller that controls a front wheel brake and a rear wheel brake; and
a controller that controls the throttle valve controller and the brake controller,
wherein the controller controls at least the throttle valve, the front wheel brake, and the rear wheel brake during turning of the motorcycle.

2. The control device for the motorcycle according to claim 1, wherein the controller operates the rear wheel brake with greater force than that for the front wheel brake during the turning of the motorcycle.
